(19) United States
(12) Patent Application Publication
(10) Pub. No.: US 2020/0368657 A1
(43) Pub. Date: Nov. 26, 2020

(54) FILTRATION DEVICE COMPRISING ATOMIC QUANTUM CLUSTERS

(71) Applicants: YPF TECNOLOGÍA S.A., Ciudad Autonoma de Buenos Aires (AR); NANOGAP SUB-NM-POWDER, S.A., Ames (ES)

(72) Inventors: Walter Alberto VARGAS, La Plata (AR); Roberto Federico PEREIRAS, Quilmes (AR); María Clara PAGLIARICCI, La Plata (AR)

(21) Appl. No.: 16/871,405

(22) Filed: May 11, 2020

Related U.S. Application Data
(60) Provisional application No. 62/846,051, filed on May 10, 2019.

(51) Int. Cl. B01D 39/20; C02F 1/00

(52) U.S. Cl. CPC B01D 39/2027; C02F 1/001; B82Y 30/00; B01D 2201/31; B01D 2201/04

(57) ABSTRACT

A filtration device with biocidal effect for the elimination of microorganisms in polluted waters. The device comprises an outer shell and a plurality of filtration plates that can be fitted together stacked up inside the outer shell, thus forming a filtration filler between the inlet section and the outlet section. The filtration plates comprise immobilized atomic quantum clusters (AQCs) on their surfaces.

### TECHNICAL FIELD

The present invention refers to the technical field of water treatment for the elimination of contaminants. Specifically, the present invention refers to a filtration device with biocidal effect for the elimination of microorganisms in contaminated waters.

### PRIOR ART

Water treatment using filtration devices allows to solve contamination problems associated with microorganisms, such as bacteria, fungi, moulds, etc. In particular, in the oil and gas industry, the microbiological activity due to the large volumes of water involved can cause corrosion phenomena in industrial installations, for which treatment equipment on an industrial scale is required to eliminate contaminants from large quantities of liquids.

Filtration devices that possess an active ingredient with a biocidal effect are known in the prior art, for example, a chemical such as tetrakis(hydroxymethyl)phosphonium sulfate (THPS) or sodium hypochlorite. In these devices, depletion of the active ingredient due to various physicochemical phenomena progressively decreases the biocidal effect, and thus maintenance and recovery cycles of industrial equipment are required, with their associated costs. In general, it is necessary to periodically replace the active ingredient in a high proportion.

Therefore, there is a need to provide a filtration device whose biocidal effect does not depend on an active ingredient subject to depletion, or which can be easily controlled and repaired should the biocidal effect decrease.

Atomic quantum clusters (AQCs), such as those described in published application WO 2007/017550, are clusters made up of a discrete number of atoms that constitute “metallic molecules”. Their antifungal, antimicrobial and biocidal properties at reduced concentrations have been described in published application WO 2009/043958.

However, due to the reduced mass of said AQCs, it is difficult to use them in industrial equipment operating with large fluid flows, mainly because they are dragged by the fluid that circulates in such equipment.

Thus, there is a need to provide a filtration device that overcomes the disadvantages of the prior art related to the depletion of the biocidal effect and the dragging of AQCs.

### BRIEF DESCRIPTION OF THE INVENTION

The present invention advantageously overcomes the shortcomings of the prior art due to depletion of the biocidal effect, using atomic quantum clusters (AQCs), as well as inconveniences due to the filtration fluids dragging the AQCs.

Therefore, an object of the present invention is a filtration device comprising:
an outer shell comprising an inlet section and an outlet section, and
a filtration filler between the inlet section and the outlet section,
wherein the filtration filler comprises immobilized atomic quantum clusters (AQCs).

In a preferred embodiment, the filtration filler comprises a plurality of filtration plates that can be fitted together stacked up inside the outer shell.

Therefore, an object of the present invention is a filtration device comprising:
an outer shell comprising an inlet section and an outlet section, and
a plurality of filtration plates that can be fitted together stacked up inside the outer shell and making up a filtration filler between the inlet section and the outlet section,
wherein the filtration plates comprise immobilized atomic quantum clusters (AQCs).

In a preferred embodiment, the AQCs are immobilized by a support comprising a polymer matrix. Preferably, the polymer matrix comprises an acrylate resin. More preferably, the polymer matrix further comprises an epoxy resin or an epoxy-urethane resin.

In another preferred embodiment, the AQCs are embedded in the polymer material of the filtration plates.

In a preferred embodiment, the AQCs are composed of atoms from a metal selected from a group consisting of Au, Ag, Co, Cu, Pt, Fe, Cr, Pd, Ni, Rh, Pb and combinations thereof.

In a preferred embodiment, the filtration plates are longitudinal. Preferably, the longitudinal filtration plates comprise a grooved surface with triangular wedges.

In another preferred embodiment, the filtration plates are transverse. Preferably, the transverse filtration plates comprise an outer circumference and a plurality of grooved surfaces with triangular wedges extending diametrically through the outer circumference.

In a preferred embodiment, the inlet section and the outlet section have pipe coupling means. Preferably, said coupling means comprise a thread or a flange.

The device of the invention presents a high percentage of elimination of microorganisms in relation to the head loss of the liquid to be filtered. Preferably, the percentage of elimination of microorganisms is between 90 and 100%, more preferably around 99%, head loss being between 10 and 40 kPa, more preferably around 14 kPa.

### BRIEF DESCRIPTION OF THE FIGURES

The figures show embodiments of the filtration device of the present invention. Embodiments of the device with longitudinal filtration plates and with transversal filtration plates are shown.

FIG. 1 shows the device of the present invention joined to two tube endings by threaded joints.

FIG. 2 shows the interior of the device of the present invention, corresponding to the embodiment with longitudinal filtration plates.

FIG. 3 shows a section of the interior of the device of the present invention, corresponding to the embodiment with longitudinal filtration plates.

FIG. 4 shows a section of the interior of the device of the present invention close to the outlet end, corresponding to the embodiment with longitudinal filtration plates.

FIG. 5 shows a cutaway view of the interior of the device of the present invention wherein the longitudinal filtration plates stacked up and fitted together according to an embodiment are shown.

FIG. 6 shows a cutaway view of the interior of the device of the present invention wherein the longitudinal filtration plates stacked up and fitted together according to an embodiment are shown.

FIG. 7 shows a cutaway view of an end of the device of the present invention comprising a tube coupling flange.

FIG. 8 shows longitudinal filtration plates of the device of the present invention.

FIG. 9 shows the interior of the device of the present invention, corresponding to the embodiment with transversal filtration plates.

FIG. 10 shows a section of the interior of the device of the present invention close to an end, corresponding to the embodiment with transversal filtration plates.

FIG. 11 shows a section of the interior of the device of the present invention close to an end, wherein the transverse filtration plates stacked up and fitted together are shown.

FIG. 12 shows transversal filtration plates of the device of the present invention.

### DETAILED DESCRIPTION

The invention and its embodiments will be described in further detail below, with reference to the accompanying figures.

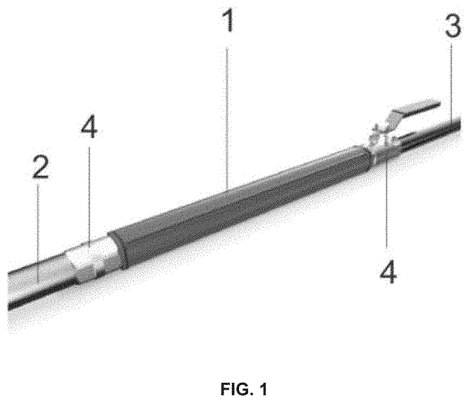

As seen in FIG. 1, the device (1) has an outer shell that protects the other components and provides structural integrity to the filtration filler, as will be detailed below. Preferably, the outer shell is cylindrical. The outer shell is composed from any material resistant to corrosion by water or other fluids used in the industry. In particular, it may be of polymer material and may be obtained by any adapted method, for example, by 3D printing.

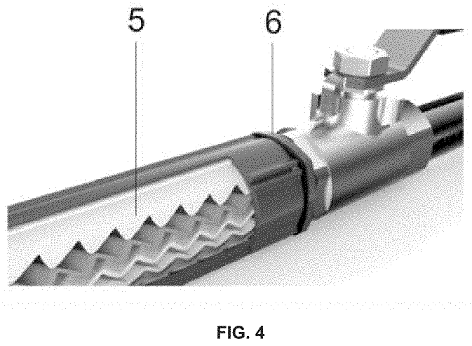

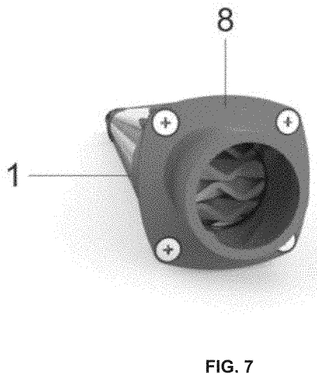

The outer shell has an inlet section at one end and an outlet section at another end, which may be coupled to the ends of an inlet (2) pipe and an outlet (3) pipe, respectively, through which the fluid to be filtered circulates. The filtration device (1) may be introduced into and removed from the pipe ends (2, 3) quickly and efficiently by means of coupling elements (4) provided in the inlet and outlet sections, which may be connected to pipe ends. Said coupling elements (4) may be, for example, a thread or a flange (8) provided at one end (6) as observed in FIGS. 4 and 7.

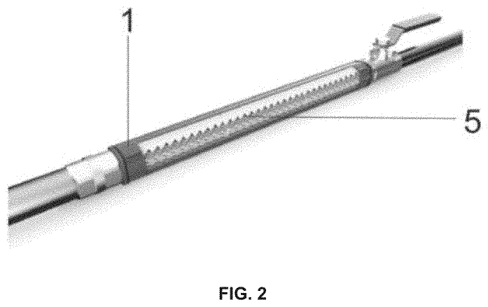

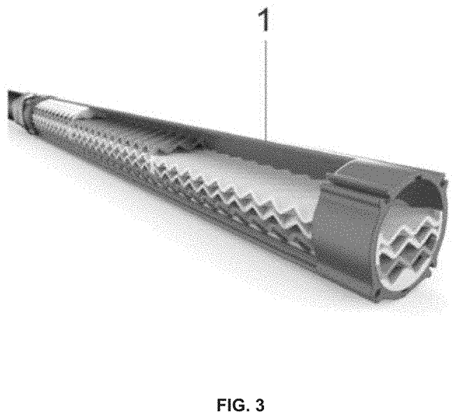

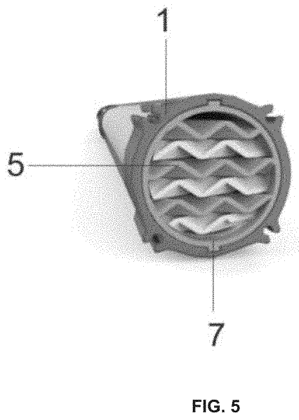

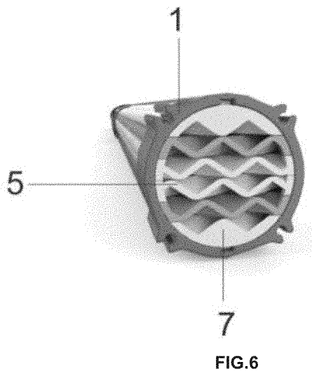

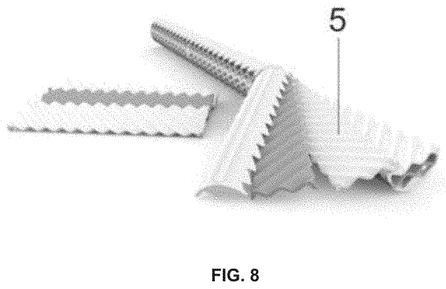

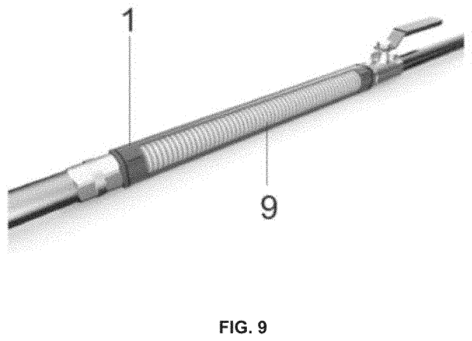

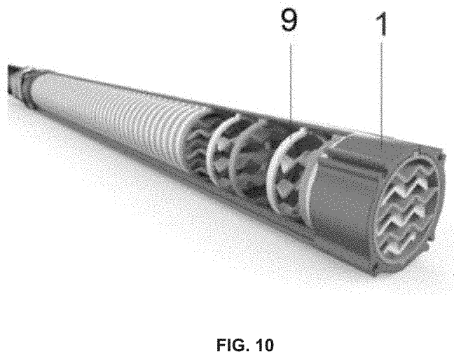

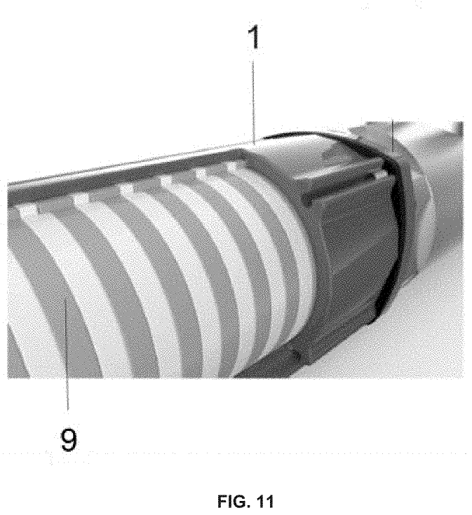

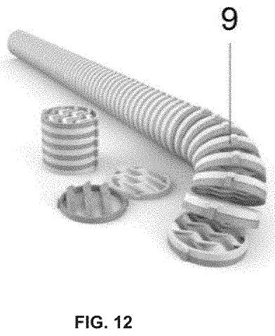

The device (1) has filtration plates that define a filtration filler, as will be described hereinbelow. The filtration plates may be stacked one onto another. The filtration plates may be longitudinal, as observed in FIGS. 2 to 8, or transversal, as observed in FIGS. 9 to 12.

The design and arrangement of the plates is done so as to maximize the contact area of the fluid with the surface, without resulting in a significant pressure drop.

The longitudinal filtration plates (5) are plates of a given length and a width that varies according to the position of the longitudinal filtration plate in the stack (7), obtained by a plurality of stacked longitudinal filtration plates. The longitudinal filtration plate located at a medium height has a width that is equal to the inner diameter of the outer shell, the plates located at heights different from the medium height have a decreasing width. The longitudinal filtration plates have a grooved or corrugated surface by means of folds. When these folds have a triangular cross section, they are called “triangular wedges”.

As observed in FIGS. 9 to 12, the transverse filtration plates (9) have an outer portion defining a closed curve, for example, a circumference, and a plurality of grooved surfaces with triangular wedges extending from one end to the other of the closed curve defined by the outer portion and are contained in the area enclosed by the closed curve defined by the outer portion. The grooved surfaces with triangular wedges may be parallel one to the other. When the transverse filtration plates are stacked one onto the other, the grooved surfaces of said plate are aligned so as to form a grooved longitudinal surface with triangular wedges.

The filtration plates may be fitted together, that is, the upper or front portion of a plate has a shape that partially corresponds to the lower or back portion of the other plate, depending on whether they are longitudinal (5) or transversal (9) filtration plates, so that a close contact is made between them when they are positioned one onto the other. When all the filtration plates of the device are stacked and fitted together, the solid defined by the totality of the plates forms a “filtration filler”, within which the fluid to be treated circulates, entering the device through the inlet section and exiting through the outlet section. By stacking and fitting the filtration plates together, flow grooves are provided, through which the fluid to be filtered circulates.

Said filtration filler may be equal to those used in monolithic reactors or bed reactors with static mixers. Thus, the longitudinal (5) or transversal (9) filtration plates may be obtained as longitudinal and transversal “cuts” of a filtration filler.

Different flow configurations of the filtration filler may be obtained by modifying the constructive characteristics of each filtration plate.

In an embodiment, the filtration filler further comprises deflectors to allow for static mixing. The device may be built modularly using filtration fillers, wherein each of the filtration fillers has a length of approximately 300 mm and a diameter of approximately 0.0245 m, with deflectors that form a 17° angle around the axis of the filtration device and which are approximately 75 mm apart. Between 5 and 6 modules in static flow configuration may be arranged in series in order to build the device.

In an embodiment, the filtration filler promotes crossflow of the fluid to be filtered, as in “Sulzer type” mixer systems. In this crossflow embodiment, the filtration filler has a length of approximately 100 mm and a diameter of approximately 0.02678 m.

The filtration plates may be made from any material that is resistant to corrosion from water or other fluids used in the industry. In particular, the filtration plates may be made from polymer material and may be obtained by any adapted method, for example, 3D printing.

The device of the present invention comprises atomic quantum clusters (AQCs) with biocidal effect. Said clusters are composed of a discrete number of atoms, preferably between 2 and 100 metal atoms, such as Au, Ag, Co, Cu, Pt, Fe, Cr, Pd, Ni, Rh, Pb and combinations thereof. More preferably, the Ag AQCs Ag are composed by 5 to 25 atoms.

In the device of the present invention, the AQCs are present in an amount such that the ratio between AQCs mass and the liquid volume contained within the device in a given moment is of the order of ppb. This concentration is relatively lower than that of other active ingredients having a biocidal effect, which are in general in ratios between 50 and 500 ppm.

Fixing the AQCs to the filtration plates allows to decrease their dragging by the liquids that go through the device. The AQCs are immobilized on the filtration plates by means of a support. Said support preferably comprises a polymer matrix, preferably an acrylate resin. Preferably, said acrylate resin is cured with an epoxy resin or epoxy-urethane so as to immobilize the AQCs to the filtration plates. More preferably, said resins are cured by UV radiation. Optionally, the polymer matrix may comprise additives. Without wishing to be bound by theory, interactions between the polymer matrix and the AQCs allows them to be properly immobilized on the filtration plates and avoids their being dragged by the liquids that circulate in the filtration device.

Surprisingly, it has been found that the geometry of the filtration filler defined by the filtration plates and the immobilization of AQCs on said plates allows to obtain an enhanced biocidal effect with respect to the use of AQCs in solution. Further, dragging of AQCs by liquids is avoided, increasing efficiency of the filtration process and minimizing its possible environmental impact with respect to other flow configurations. Finally, AQCs do not show significant exhaustion of their biocidal effect and may be easily regenerated, this resulting in more economical operation with reduced maintenance cycles.

### Exemplary Embodiments

1) AQCs Biocidal Effect

The biocidal effect of an AQCs aqueous solution was tested in microorganisms, including gram-negative bacteria, such as Escherichia coli and Desulfovibrio desulfuricans and arches such as Haloferax volcanii.

To this end, solutions of Ag and Cu AQCs in water were prepared, in concentrations of 0.1 to 30 mg/L of AQCs

In Escherichia coli cultures, it was observed that Ag AQCs possess biocidal effect, reducing the number of bacteria by 100% using solutions in water of 20 to 25 mg/L, diluted 1/10, and by about 80-90% using solutions diluted 1/100.

Moreover, a reduction of more than 95% of microorganisms in production waters was observed using solutions diluted in a range of 1/10 to 1/25.

2) AQCs Immobilization

AQCs used for the filtration device were dissolved in 50 mL of 1,6-hexanediol diacrylate (HDDA) supplied by Sigma-Aldrich, thus producing AQC solutions in a concentration range of approximately 0.1 to 1% p/v.

Subsequently, the solution containing the AQCs was mixed with a polyurethane resin solution supplied by Gairesa (GAIDUR), compatible with the acrylic solution. The resulting liquid mixture is deposited on filtration plates using the centrifugal deposition technique or spin-coating and then cured by UV radiation to obtain a polymer matrix where the AQCs are immobilized and fixed on the filtration plates.

It was observed that concentrations of Ag AQCs in the polymer matrix in a range of 10 to 100 ppm provide a biocidal effect, allowing 100% reduction in viability of Escherichia coli cultures, and 99% reduction in Desulfovibrio desulfuricans and Haloferax volcanii cultures.

3) Filtration Device

The device of the present invention was tested to filter production water from the oil and gas industry, which was contaminated with Escherichia coli, using Ag AQCs. Flow assays corroborate the efficiency of the device, eliminating 99.9% of the water bacterial content when water circulates through the filter, either by the effect of gravity or using pressurization systems.

The biocidal effect was assessed under high salinity conditions. For this purpose, salt solutions containing Ag AQCs in concentrations of 0.1 ppm, 1 ppm and 10 ppm and NaCl in concentrations of 70 to 80 parts per thousand were prepared, simulating the conditions found in facilities associated with unconventional oil and gas wells.

Furthermore, the biocidal effect of AQCs incubated between 3 h and 24 h at 25° C., 60° C. y 100° C. was assessed.

The device of the present invention allows to obtain reductions in microorganism concentrations of about 95%, similar to those obtained using similar devices of the prior art, but using an amount of AQCs equivalent to a dose 25 to 60 times lower than doses of other active ingredients with biocidal effect of the prior art, such as THPS or sodium hypochlorite.

Additionally, the device allows to treat high salinity water at higher operational temperatures than similar devices of the prior art.

According to experimental tests, the filtration device may treat flowrates between 18 and 40 m³/day with average flow speeds between 0.4 and 1 m/s while maintaining the previously mentioned elimination efficiency.

Head loss between the inlet and the outlet of the filtration device is typically 14 kPa, and generally between 10 and 40 kPa, depending on the flow configuration of the filtration filler. Although a crossflow configuration produces a detectable head loss, the biocidal effect of such configuration is increased. Without wishing to be bound by theory, said increase may be due to the increase of mass transfer coefficients in the system.

The filtration device presents an advantageous biocidal effect efficiency to head loss ratio, as a result of a maximized contact area provided by the filtration filler and its combination with the biocidal effect of the AQCs.

1. A device comprising:
an outer shell comprising an inlet section and an outlet section, and
a plurality of filtration plates that can be fitted together stacked up inside the outer shell and forming a filtration filler between the inlet section and the outlet section,
wherein the filtration plates comprise immobilized atomic quantum clusters (AQCs).

2. The device according to claim according to claim 1, wherein the AQCs are immobilized by a support comprising a polymer matrix or are embedded in the polymer material of the filtration plates.

3. The device according to claim 2, wherein the polymer matrix comprises an acrylate resin.

4. The device according to claim 1, wherein the AQCs are composed of atoms from a metal selected from a group consisting of Au, Ag, Co, Cu, Pt, Fe, Cr, Pd, Ni, Rh, Pb and combinations thereof.

5. The device according to claim 1, wherein the filtration plates are longitudinal.

6. The device according to claim 5, wherein the longitudinal filtration plates comprise a grooved surface with triangular wedges.

7. The device according to claim 1, wherein the filtration plates are transversal.

8. The device according to claim 7, wherein the transversal filtration plates comprise an outer circumference and a plurality of grooved surfaces with triangular wedges extending from one end to the other of the outer circumference.

9. The device according to claim 1, wherein the inlet section and the outlet section have pipe coupling means.

10. The device according to claim 9, wherein said coupling means comprise a thread or a flange.
